(19) United States
(12) Patent Application Publication
(10) Pub. No.: US 2025/0049015 A1
(43) Pub. Date: Feb. 13, 2025

(54) HOLDER DEVICE FOR INSECT ATTRACTANTS

(71) Applicant: Ricardo ALVARADO BERNAL, Mexico City (MX)

(72) Inventor: Ricardo ALVARADO BERNAL, Mexico City (MX)

(21) Appl. No.: 18/594,698

(22) Filed: Mar. 4, 2024

(30) Foreign Application Priority Data
Aug. 7, 2023 (MX) MX/A/2023/009228

(51) Int. Cl. A01M 1/02; A01M 1/14

(52) U.S. Cl. CPC A01M 1/02; A01M 1/14

(57) ABSTRACT

The present invention relates to a Holder Device for Insect Attractants that folds from a first position to a second position, being easily manipulated to grasp and hold attractants of different sizes. These attractants move in different areas without human contact, significantly enhancing the effectiveness of the attractants placed in the zones selected by said Holder Device for Insect Attractants.

### BACKGROUND

### 1. Field of the Invention

This invention applies to the field of monitoring and controlling economic importance pests. More specifically, it refers to a device for the biological control of insects. This device allows for the precise and reliable placement of attractants used in the biological control of insects.

### 2. General Background of the Invention

In the field of insect pest control and monitoring, there is a significant diversity of attractants that aid in this function. There is also a crucial management aspect regarding the placement of these attractants in specific using controlled means. This is done to achieve the highest efficacy and effectiveness in the environment where they are placed. However, throughout this control and monitoring process, there are no precise tools for the placement of these attractants. As a result, improvised attractant placement tools exist, and in some cases, placement is done manually.

In this context, some gripping devices can be mentioned; however, none of these devices have the specific function for holding and placing attractants. The following documents can be cited.

Chinese Patent CN 101426700 B, dated Jan. 9, 2013, titled “Gripping Element,” which describes a holding device for a container. Specifically, this invention refers to a clamp for holding plastic bottles, particularly by the bottle's neck. More specifically, it refers to a gripping clamp that prevents bottle deformation when transported at high temperatures. The device prevents the deformation of the held bottle. The device of the present invention has a base and two gripping arms, where the two gripping arms can move relatively. Each gripping arm has a gripping piece to hold the container. The curvature of at least one gripping arm between the gripping part and the base is greater than 90 degrees. Additionally, the gripping arms can be relatively separated, and in the separated state, each gripping arm will exert an elastic force towards the other gripping arm. However, the function of these arms is entirely different from what is intended to be protected in the present invention.

U.S. Pat. No. 8,701,872 B2, dated Apr. 22, 2014, titled “Clip for Capturing Bottle Necks, Particularly of PET Bottles,” describes a clip for grasping bottle necks, especially those of PET bottles in packaging plants. The arms of the clip can rotate in the horizontal plane, achieved through a simple design that retains forces as equal as possible for bottle necks of different diameters. This is accomplished using plastic clip arms containing receptacles for permanent magnets between the gripping area and the pivot axis. These magnets exert a closing force between them and prevent the bottle from coming loose. This patent includes additional elements present in gripping clamps, making the configuration more complicated than the one proposed herein, besides being within another application scope.

Therefore, due to the need for a Device Holder for Insect Attractants, which does not exist in the current market, and which would provide greater reliability and quality to insect traps, said traps armed with attractants placed on their surfaces aided by the aforementioned Attractant Holder Device would be of higher quality and reliability, the present invention implements said Attractant Holder Device.

### SUMMARY OF THE INVENTION

The present invention relates to a Device Holder for Insect Attractants, specifically designed to grip and hold baits or luring agents with pheromones (attractants), which will be placed on a surface without human contact. All the handling of the bait or luring agent is done with the assistance of the Device Holder for Insect Attractants, enabling the assembly of traps and control methods of higher quality and effectiveness due to the complete absence of human contact in the placement of attractants.

Currently, no attractant holder is used in traps for economic importance insects. Generally, attractants are placed inside traps, mostly on sticky surfaces. The device containing the attraction chemicals loses its effectiveness when it comes into contact with insect-adhesive glues, as part of its surface is covered by these adhesives upon contact.

Another deficiency is that this type of attractants are packaged in bags, and when handled by the operator to place the device inside a trap, both the operator's hands and the traps get contaminated with attraction chemicals.

The holder in my invention not only supports a specific type of attractant device but is also capable of holding different sizes and desired configurations.

Our Device Holder for Insect Attractants, when placed inside the trap with its respective bait and without contact with adhesive glues, allows us to reuse long-lasting baits without the need to discard them simultaneously with the trap, as is currently done due to the contact between the bait and the insect-holding adhesives.

By using the holder, manual contact with the operator is eliminated, allowing the device to be removed from the bait packaging without any form of contact. Moreover, the holder can be inserted into the trap in a way that avoids contact with the adhesives used to trap insects.

Another advantage is the elimination of contamination on the external parts of the trap, making it more effective and attracting insects solely into its interior for capture.

The features of this innovative Device Holder for Insect Attractants are detailed in the following description and figures of the present invention.

### BRIEF DESCRIPTION OF THE DRAWINGS

To complement the ongoing description and to aid in better understanding the features of the invention, the following drawings are included as an integral part of this description. These drawings are illustrative and not limiting, showcasing the following:

FIG. 1. Illustrates a primary frontal view of the Device Holder for Insect Attractants in a first gripping position.

FIG. 2. Illustrates a primary side view of the Device Holder for Insect Attractants in a first gripping position.

FIG. 3. Illustrates a primary top view of the Device Holder for Insect Attractants in a first gripping position.

FIG. 4. Illustrates a primary isometric view of the Device Holder for Insect Insect Attractants in a first gripping position.

FIG. 5. Illustrates another primary isometric view of the Device Holder for Insects Attractants in a first gripping position.

FIG. 6. Illustrates a primary frontal view of the Device Holder for Insect Attractants in a second gripping position.

FIG. 7. Illustrates a primary side view of the Device Holder for Insect Attractants in a second gripping position.

FIG. 8. Illustrates a primary side view of the cylindrical bait with a cross.

FIG. 9. Illustrates a primary top view of the cylindrical bait with a cross.

FIG. 10. Illustrates a primary frontal view of the Device Holder for Insect Attractants in a first gripping position of the bait.

FIG. 11. Illustrates a primary side view of the Device Holder for Insect Attractants in a first gripping position of the bait.

FIG. 12. Illustrates a primary isometric view of the Device Holder for Insect Attractants in a first gripping position of the bait.

FIG. 13. Illustrates a primary side view of the stepped conical bait.

FIG. 14. Illustrates a primary isometric view of the stepped conical bait.

FIG. 15. Illustrates a primary side view of the cylindrical bait.

FIG. 16. Illustrates a primary isometric view of the cylindrical bait.

FIG. 17. Illustrates a primary frontal view of the Device Holder for Insect Attractants in a second gripping position of the bait.

FIG. 18. Illustrates a primary side view of the Device Holder for Insect Attractants in a second gripping position of the bait.

FIG. 19. Illustrates a primary isometric view of the Device Holder for Insect Attractants in a second gripping position of the bait.

FIG. 20. Illustrates a primary frontal view of the Device Holder for Insect Attractants with an elongated spike neck formed with a rigid-flexible member to achieve the desired angular position.

FIG. 21. Illustrates a primary frontal view of the Device Holder for Insect Attractants with an elongated spike neck formed with a rigid-flexible member to achieve the desired angular position and a spike with a groove.

FIG. 22. Illustrates a primary frontal view of the Device Holder for Insect Attractants with an elongated spike neck formed with a rigid-flexible member to achieve the desired angular position and a spike with a groove.

FIG. 23. Illustrates a primary frontal view of the Device Holder for Insect Attractants in a first gripping position and the spike with a groove indentation.

### DETAILED DESCRIPTION OF THE INVENTION

The following is a detailed description of the present invention with reference to the figures.

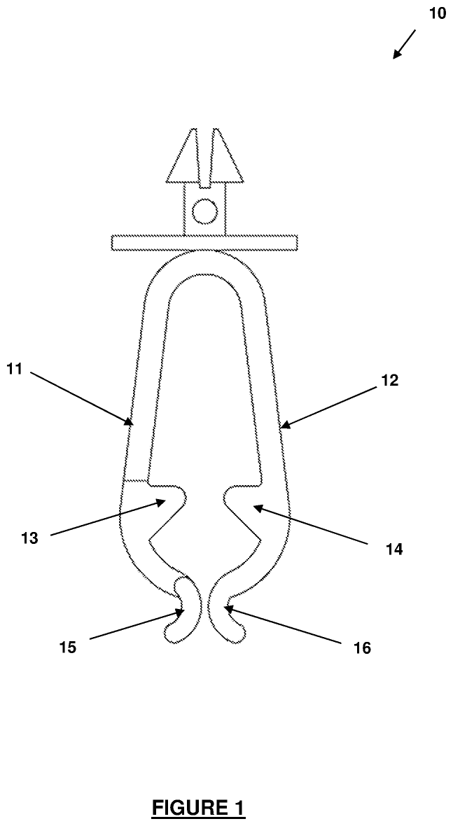

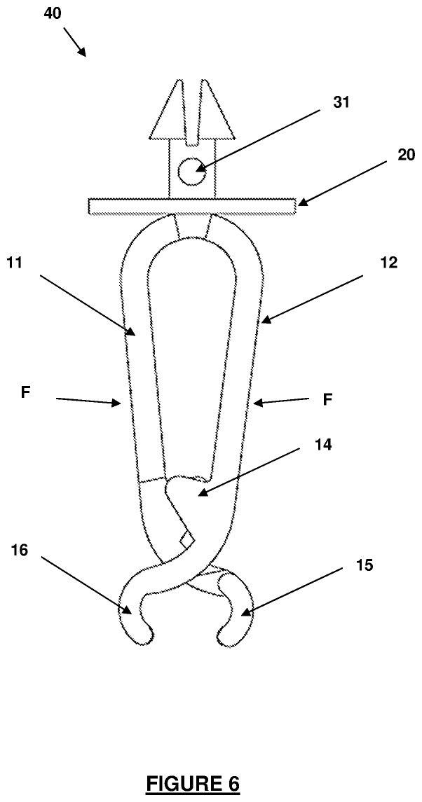

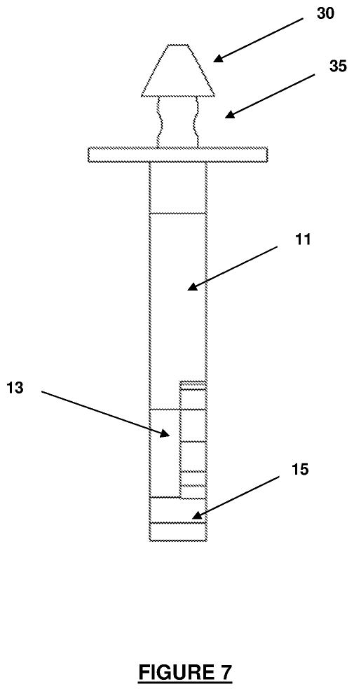

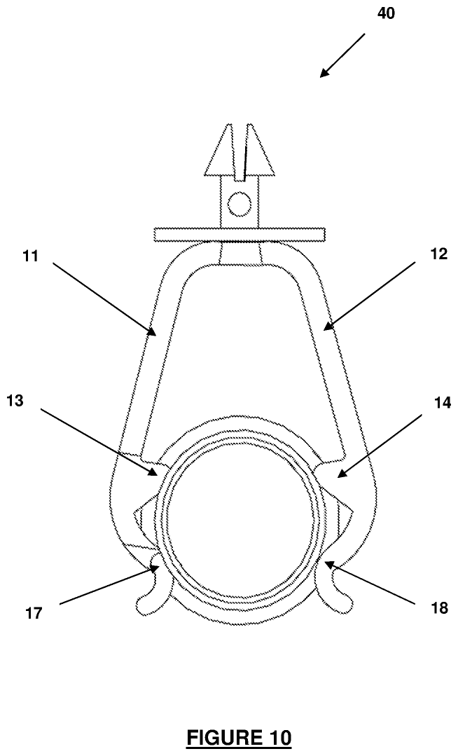

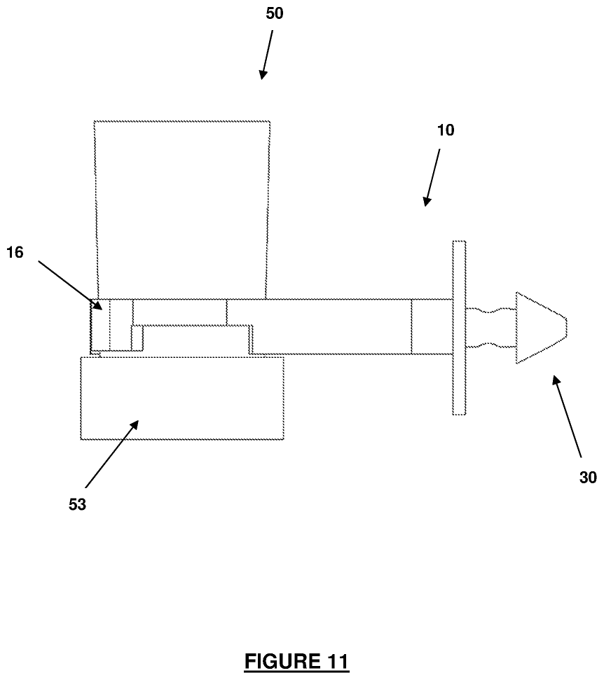

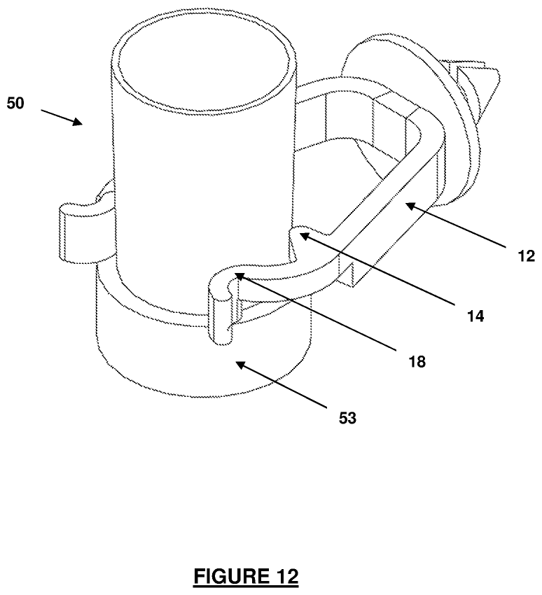

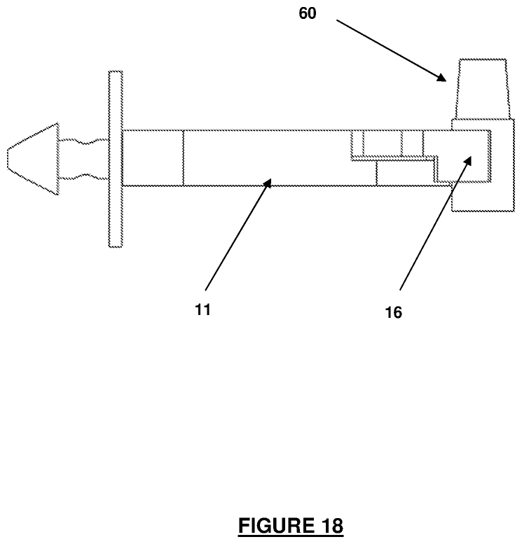

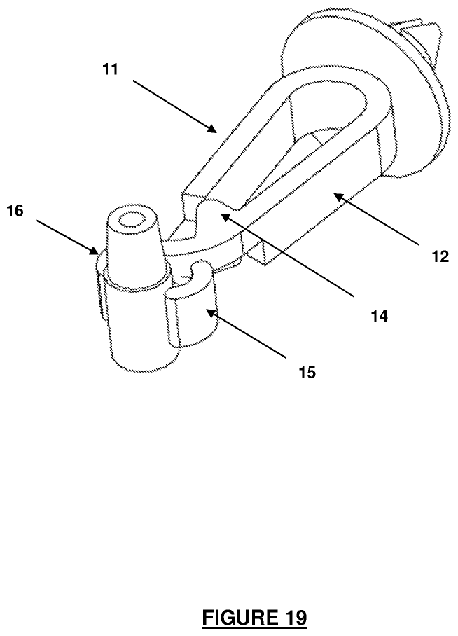

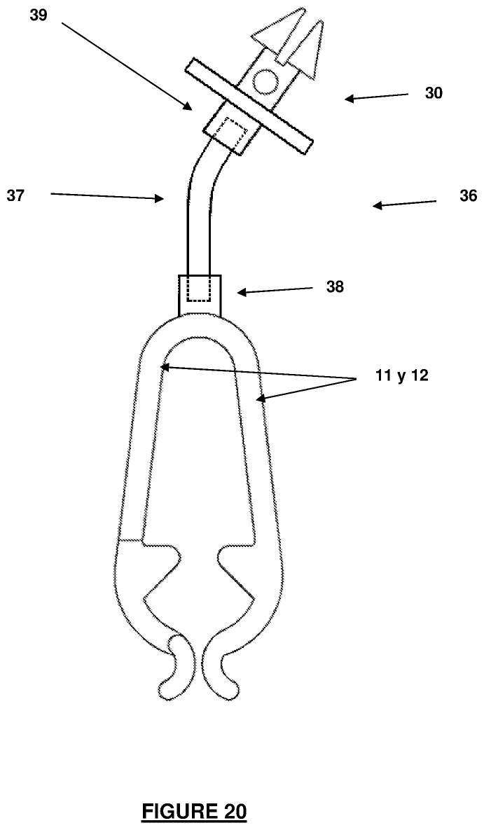

According to the present invention, FIGS. 1 to 5 show the Device Holder for Insect Attractants in a first gripping position. This first gripping position is achieved with the lower elastic gripping arm 11 and the upper elastic gripping arm 12 in a free position, allowing baits of different dimensions, especially larger diameters, to be inserted between these arms. In FIGS. 6 and 7, the Device Holder for Insect Attractants is shown in a second gripping position, where the lower elastic gripping arm 11 and the upper elastic gripping arm 12 are engaged, allowing the holding of smaller diameter baits. FIGS. 10, 11, and 12 depict bait holding using the Device Holder for Insect Attractants in a first gripping position, and FIGS. 17, 18, and 19 show bait holding using the Device Holder for Insect Attractants in a second gripping position. FIGS. 8, 9, 13, 14, 15, and 16 display the different types of baits that can be used with the Device Holder for Insect Attractants, which can be applied in a first position 10 and a second position 40. Based on the above, a detailed description of the invention is presented.

In FIGS. 1 to 5, the Device Holder for Insect Attractants is shown in a first gripping position 10. Consisting of a lower elastic gripping arm 11 and an upper elastic gripping arm 12, forming an oval where one end of the curved part joins the circular support 20, and the other end of the curved part is open and has an end holder 15 disposed on each end in the lower elastic gripping arm 11, and an end holder 16 disposed in the upper elastic gripping arm 12. It is worth noting that these holders 15 and 16 join together to form an oval with an opening at the opposite end of the circular support 20. The holders 15 and 16 have a semicircular curvature opposite each other. The lower elastic gripping arm 11 has a lower grip protrusion 13, approximately one-third from the end where the lower opening is located. This protrusion is projected towards the inside of the oval shape. The upper elastic gripping arm 12 has an upper grip protrusion 14, located approximately one-third from the end where the lower opening is located, projected towards the inside of the oval shape. The lower grip protrusion 13 and upper grip protrusion 14 do not connect or touch each other.

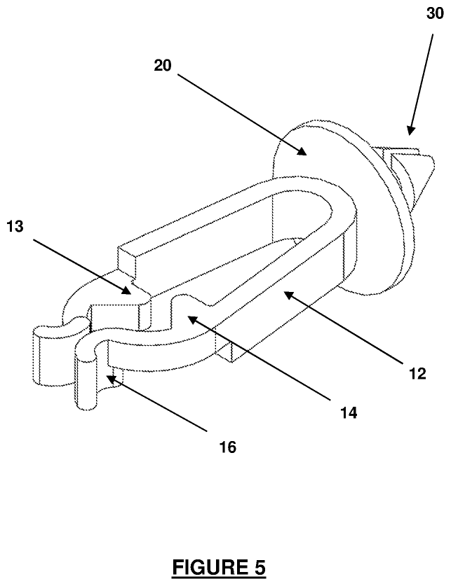

In FIG. 5, the lower elastic gripping arm 11 and the upper elastic gripping arm 12 are shown more clearly, with the lower grip protrusion 13 positioned lower than the upper grip protrusion 14. This arrangement is essential for the detailed description of the Device Holder for Insect Attractants in a second gripping position. Additionally, it's noticeable that the end holder 15 and end holder 16 have the same dimension and contact surfaces. It's important to note that the elastic gripping arms 11 and 12 can be separated from each other in a way that they do not deform and return to their initial position when not tensioned or flexed.

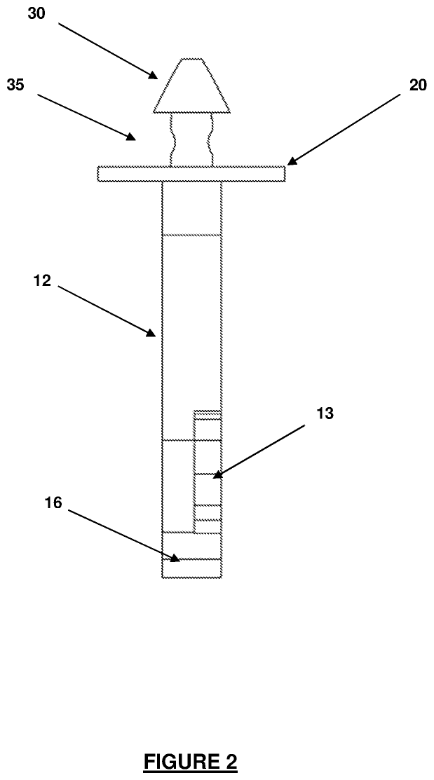

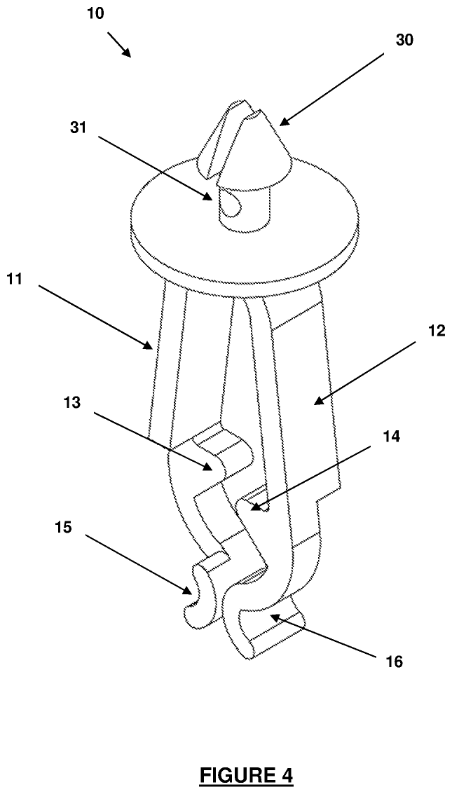

In FIG. 2, the dimensional width of the lower and upper elastic gripping arms 11 and 12 is visible, which will not exceed the diameter of the circular support 20. This figure also shows the placement of the spike connection 30 through a spike neck 35 that connects both the circular support 20 and the spike connection 30. The spike neck also functions to accommodate the holding means 31, as seen in FIG. 4, which will serve to accommodate a means of gripping or holding the Device Holder for Insect Attractants. This holding means 31 can accommodate a cord, wire, hook, or any other suitable means for gripping or holding the Device Holder for Insect Attractants.

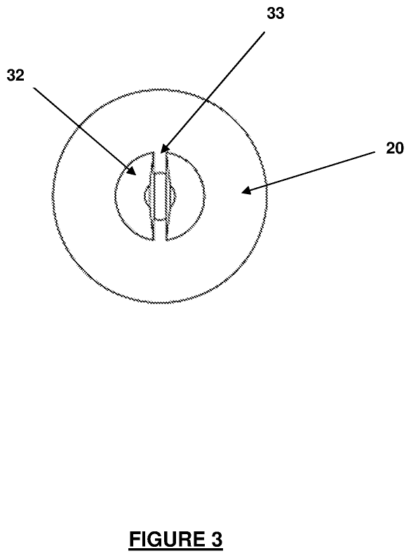

In FIG. 3, the spike connection can be seen, which is formed at the end of the spike neck 35 opposite to the circular support 20. This spike connection is formed by a truncated circular pyramid divided into two parts that create a half-spike 32 separated by a spike groove 33, thus forming the spike connection 30. This spike connection is suitable for insertion into a handle, spindle, lever that provides greater support to the Device Holder for Insect Attractants when it is used to grip, hold, and place the bait with attractant in the intended location.

The Device Holder for Insect Attractants is preferably made of a resilient and highly elastic plastic in the gripping arms, as this elasticity allows for grasping, holding, and placing the baits during handling. However, said invention can also be made with metals that fulfill the required functions of strength and flexibility. Ceramic materials or those meeting the desired function are not excluded. The circular support can be made of a sturdy material such as plastics, metals, ceramics, or any other suitable material that serves the intended purpose. Finally, the spike connection and the spike neck can also be made of materials like plastics, metals, ceramics, or any other material that fulfills the desired function. The manufacturing process for the Device Holder for Insect Attractants is achieved through plastic molding, where the piece can be obtained in a single mold and through a simple injection process.

The Device Holder for Insect Attractants configured in a second position 40 is achieved by moving from the first position to the second position, crossing the upper elastic gripping arm 12 over the lower elastic gripping arm 11 in a way that the upper protrusion 14 ends up on top of the lower protrusion 13. This transformation of the same device into two variants is possible due to the flexibility of the elastic gripping arms 11 and 12. Importantly, the arrangement of the gripping protrusions and gripping arms of the device allows this transformation into the two variants.

In FIGS. 6 and 7, the Device Holder for Insect Attractants is shown in a second gripping position 40, where a lower elastic gripping arm 11 and an upper elastic gripping arm 12 form an oval. One end of the curved part is joined to the circular support 20, and the other end of the oval part is movable and has an end holder 15 disposed on each end in the lower elastic gripping arm 11, and an end holder 16 disposed in the upper elastic gripping arm 12. These holders 15 and 16 form a closed oval that is also movable. The holders 15 and 16 have a semicircular curvature forming an oval, suitable for gripping and holding a bait. The lower elastic gripping arm 11 has a lower grip protrusion 13 (see FIG. 6), projected towards the inside of the oval shape, located approximately one-third from the end where the lower opening is located. The upper elastic gripping arm 12 has an upper grip protrusion 14 (see FIG. 6), projected towards the inside of the oval shape, located approximately one-third from the end where the lower opening is located. These lower 13 and upper 14 grip protrusions overlap, causing an opening of the holders 15 and 16 when the elastic gripping arms 11 and 12 are pressed with a force “F” (as indicated in FIG. 6). This action allows the desired bait to be gripped and held for subsequent placement in the intended location without human contact.

In FIG. 7, the dimensional width of the lower and upper elastic gripping arms 11 and 12 is visible, which will not exceed the diameter of the circular support 20. This figure also shows the placement of the spike connection 30 through a spike neck 35 that connects both the circular support 20 and the spike connection 30. The spike neck also functions to accommodate the holding means 31, as seen in FIG. 4, which will serve to accommodate a means of gripping or holding the Device Holder for Insect Attractants.

In FIGS. 6 and 7, the spike connection can be seen, formed at the end of the spike neck 35 opposite the circular support 20. This spike connection is shaped like a truncated circular pyramid divided into two parts forming a half-spike 32 separated by a spike groove 33, resulting in the spike connection 30. This spike connection is suitable for insertion into a handle, spindle, or lever that provides greater support to the Device Holder for Insect Attractants when used to grip, hold, and place the bait with attractant in the intended location.

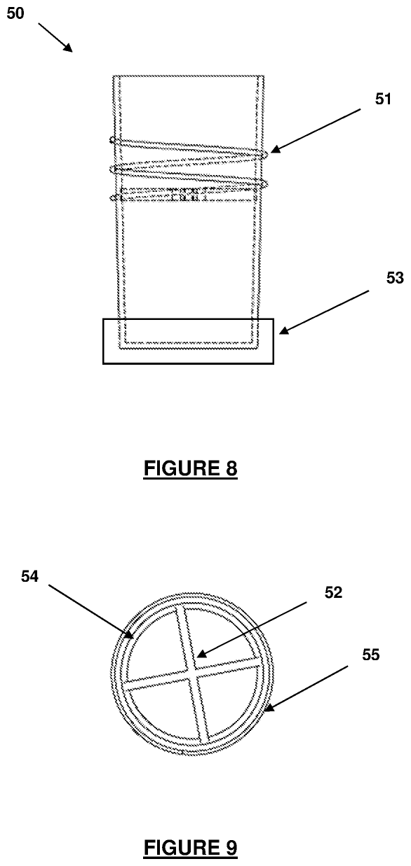

In FIGS. 8 and 9, a cylindrical bait 50 with an internal or external rope 51 can be observed. This cylindrical bait presents a crosspiece 52 on its inner part and a base 53 at its bottom. The cylindrical bait has an outer wall 55 and an inner wall 54, resulting in a longitudinally hollow cylinder with a closed base 53. The crosspiece is positioned inside the cylinder at a mid-length distance. This cylindrical bait with a crosspiece 50 can also be solely cylindrical, closed at one end, and hollow lengthwise, to deposit the suitable attractant for insects inside the hollow part.

In FIGS. 10, 11, and 12, the attachment of the cylindrical bait with a crosspiece 50 to the Device Holder for Insect Attractants in a first position is illustrated. Here, the lower elastic gripping arms 11 and the upper elastic gripping arm 12 are opened, and the cylindrical bait with a crosspiece 50 is inserted between the grip protrusions 14 and 15, and the end fasteners 15 and 16 on their grip surfaces, specifically the lower end fastener grip surface 17 and the upper end fastener grip surface 18. This provides four points of attachment for the cylindrical bait with a crosspiece 50 or solely cylindrical bait. To achieve this grip, the cylindrical bait is gently introduced through the grip surfaces of the end fasteners 17 and 18, as the elastic gripping arms 11 and 12 do not exert considerable force. The bait 50 can be grasped smoothly and deposited with the help of the force contained by the elastic gripping arms 11 and 12 without additional force. This operation is crucial as gripping and depositing the bait on the desired surface without human contact is the objective of the present invention. In situations where the bait needs to be placed at considerable distances, an arm extension means will be inserted into the spike connection 30 to extend the gripping and deposition length of the bait 50.

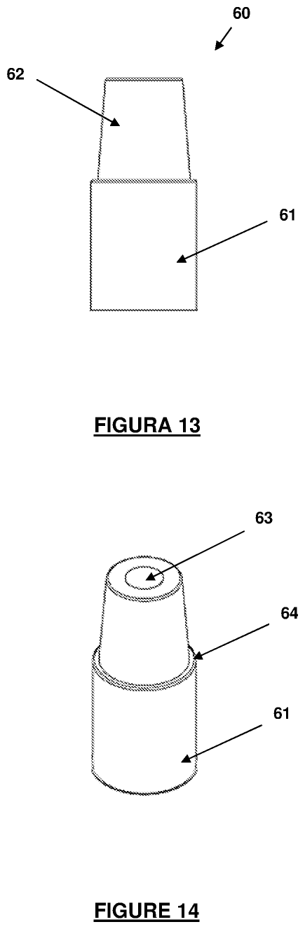

FIGS. 13 and 14 illustrate a conical bait 60, which features a lower cylindrical part 61 and an upper conical part 62, divided by a step 64. The stepped conical bait 60 has an internal hole 63 that does not pass entirely through it, allowing the placement of insect attractants in the hole 63.

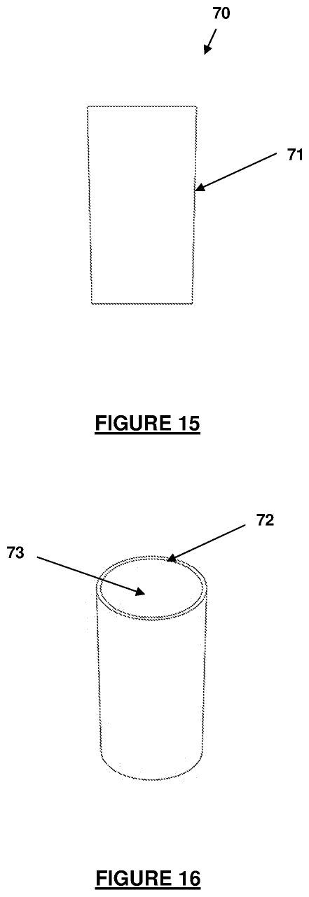

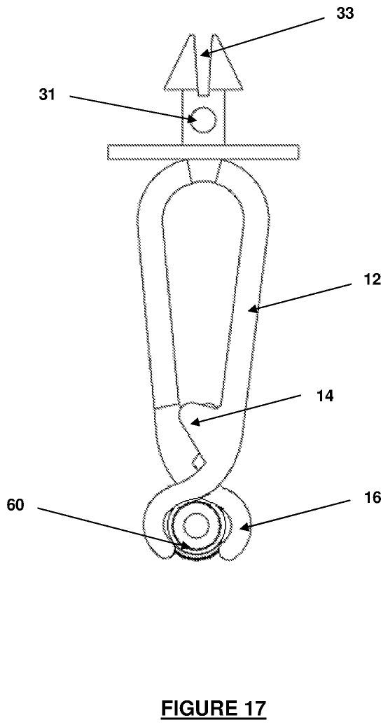

FIGS. 15 and 16 show a cylindrical bait 70, which is longitudinally hollow with one closed end and an outer wall 71 and an inner wall 72, creating a central cavity for placing the attractant.

In FIGS. 17, 18, and 19, the Device Holder for Insect Attractants is shown in a second gripping position 40, where force “F” has been applied to the elastic gripping arms 11 and 12 to open the end fasteners 15 and 16 and insert the stepped conical bait 60 or cylindrical bait 70 into them, grasping it without human intervention. It's important to note that the gripping force is sufficient to hold the bait and place it on the desired surface without excessive force to grip and deposit the stepped conical bait 60 or cylindrical bait 70.

FIG. 20 illustrates a Device Holder for Insect Attractants with an elongated spike neck 36, consisting of a rigid-flexible member 37 allowing angulation or maintaining a straight position. This rigid-flexible member 37 can be a malleable wire or tube made of flexible materials such as pliable plastic or metal, or any other material fulfilling the properties of rigidity and flexibility. This property enables the desired angulation or straightness between the spike 30 and the gripping arms 11 and 12. The rigid-flexible member 37 is inserted at one end with a coupling for rigid-flexible member 38 and at the opposite end with a circular support coupling for rigid-flexible member 39. These couplings 38 and 39 are capable of securely housing one end of the rigid-flexible member 37, allowing manipulation of the rigid-flexible member to achieve the desired angular position for placement in the triangular trap, ensuring the Device Holder for Insect Attractants is properly positioned with the bait in the trap.

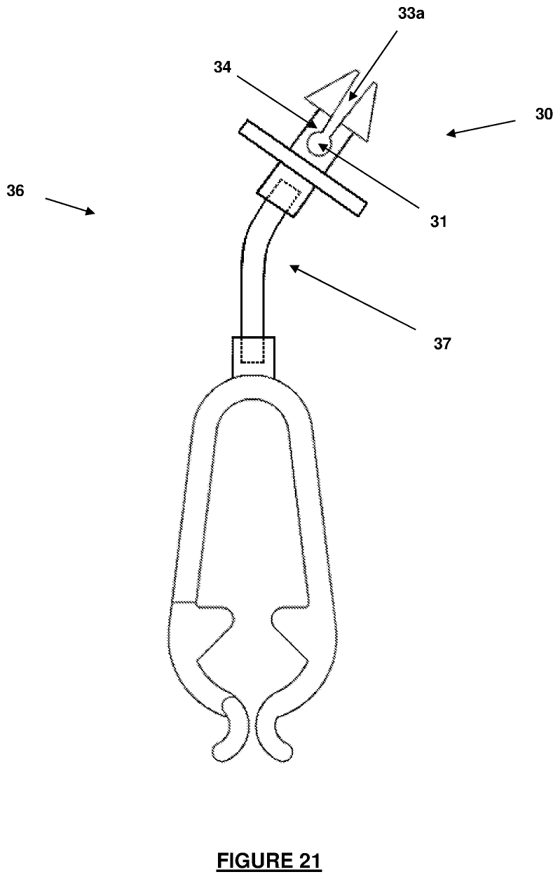

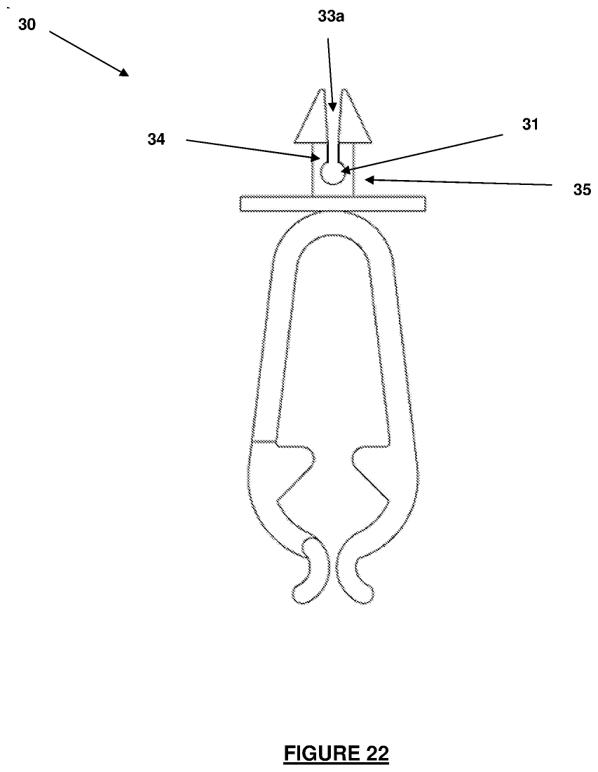

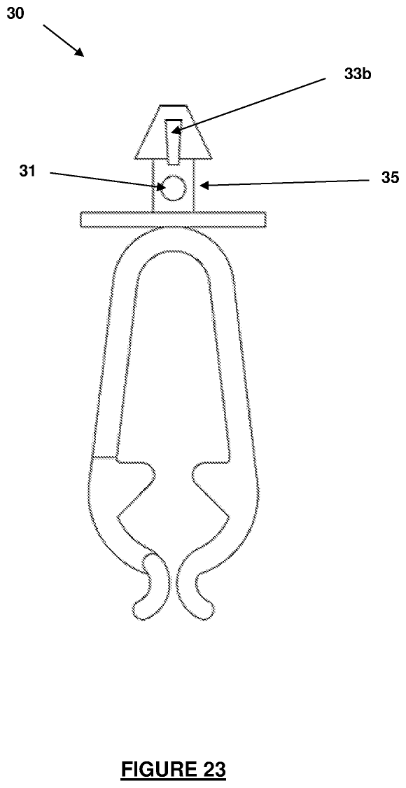

FIG. 21 shows a a Device Holder for Insect Attractants, featuring an elongated spike neck 36, formed by a rigid-flexible member 37 allowing angulation or a straight position of the elongated spike neck 36. This variation retains the same characteristics as the Device Holder for Insect Attractants in FIG. 20, except for a modification in the spike connection 30. The spike connection now includes a passed spike groove 33a that intercepts the fastening means 31, thus creating a continuous channel from the tip of the spike connection 30 to the fastening means 31. This elongated spike groove 33a allows the insertion along its length of a fastener (not shown), such as rigid or flexible wires or hooks introduced through the passed groove 33a. It's worth noting that this passed groove 33a has flexibility along its length, allowing the passage of a larger area fastener but smaller than the area of the fastening means 31. By forcing the fastener through a clip step 34 formed between the passed spike groove 33a and the fastening means 31, the fastener is secured in the fastening means 31, allowing for a practical and secure fastener insertion and removal from the fastening means.

In FIG. 23, a Holder Device for Insect Attractants is presented, comprising elements such as a standard-length spike neck 35. This variant maintains the same characteristics as the Holder Device for Insect Attractants shown in FIGS. 1 to 7, with an exception in the spike connection 30, which now features a closed groove 33b. This groove is bounded at its ends by the upper part of the spike connection 30 and at its lower part by a securing means 31, forming a closed or boxed groove. This closed groove 33b allows the insertion of a rigid or flexible hook or a rigid or flexible wire (not shown) into the closed groove 33b, enabling the attachment to be firmly and practically inserted into the securing means. This modification facilitates the practical insertion and removal of the attachment from the securing means.

For a better understanding of the invention, all of the parts comprising the Holder Device for Insect Attractants are listed below:
10 Holder Device for Insect Attractants in the first gripping position
11 lower elastic gripping arm
12 upper elastic gripping arm
13 lower gripping protrusion
14 upper gripping protrusion
15 lower end fastener
16 upper end fastener
17 gripping surface of the lower end fastener
18 gripping surface of the upper end fastener
20 circular support
30 spike connection
31 fastening means
32 half spike
33 spike slot
33a passed spike slot
33b closed spike slot
34 clip passage
35 spike neck
36 elongated spike neck
37 rigid-flexible member
38 arms coupling for rigid-flexible member
39 circular support coupling for rigid-flexible member
40 Insect Attractant Holder Device in the second gripping position
50 cylindrical bait with crosspiece
51 rope
52 crosspiece
53 cylindrical bait base with crosspiece
54 internal wall of cylindrical bait with crosspiece
55 external wall of cylindrical bait with crosspiece
60 stepped conical bait
61 stepped conical bait cylindrical part
62 stepped conical bait conical part
63 internal hole of stepped conical bait
64 stepped of stepped conical bait
70 cylindrical bait
71 external wall of cylindrical bait
72 internal wall of cylindrical bait
73 central hole

1. A Holder Device for Insect Attractants that folds from a first gripping position to a second gripping position of bait, which is comprised of: a lower elastic gripping arm and an upper elastic gripping arm, said arms forming an oval where one end of the curved part joins a circular support, and the other end of the curved part is open and has at each end a lower end fastener arranged on the lower elastic gripping arm, and an upper end fastener arranged on the upper elastic gripping arm, the lower elastic gripping arm has a lower gripping protrusion, and the upper elastic gripping arm has an upper gripping protrusion, said lower and upper gripping protrusions do not join or touch each other and a spike connection which is formed at the end of the spike neck opposite to the circular support.

2. A Holder Device for Insect Attractants that folds from a first gripping position to a second gripping position of bait in accordance with claim 1, wherein the fasteners are joined forming an oval with an opening at its end opposite to the circular support, the fasteners have an opposite semicircular curvature between them.

3. A Holder Device for Insect Attractants that folds from a first gripping position to a second gripping position of bait in accordance with claim 1, wherein a lower gripping protrusion is located approximately at one third of the end where the lower opening is located.

4. A Holder Device for Insect Attractants that folds from a first gripping position to a second gripping position of bait in accordance with claim 1, wherein the protrusion is a projection towards the inner part of the oval shape.

5. A Holder Device for Insect Attractants that folds from a first gripping position to a second gripping position of bait in accordance with claim 1, wherein the upper elastic gripping arm has an upper gripping protrusion, located approximately at one third of the end where the lower opening is located, which is a protrusion projected towards the inner part of the oval shape.

6. A Holder Device for Insect Attractants that folds from a first gripping position to a second gripping position of bait in accordance with claim 1, wherein said spike connection is formed by a circular truncated pyramid divided into two parts that form a half spike divided by a spike slot.

7. A Holder Device for Insect Attractants that folds from a first gripping position to a second gripping position of bait in accordance with claim 1, wherein the spike connection is suitable for insertion into a handle, spindle, lever that allows providing greater support to the Holder Device for Insect Attractants.

8. A Holder Device for Insect Attractants that folds from a first gripping position to a second gripping position of bait in accordance with claim 1, wherein the spike neck also serves to accommodate the fastening means.

9. A Holder Device for Insect Attractants that folds from a first gripping position to a second gripping position of bait in accordance with claim 1, wherein a second position, transitioning from the first position to the second position is achieved by crossing the upper elastic gripping arm over the lower elastic gripping arm so that the upper protrusion is positioned above the lower protrusion, achieved by the flexibility present in the elastic gripping arms that allows this transformation of the same device into two variants.

10. A Holder Device for Insect Attractants that folds from a first gripping position to a second gripping position of bait in accordance with claim 1, wherein the fasteners are joined thus forming a closed oval which is also movable, the fasteners have a semicircular curvature forming an oval, which is suitable for grasping and holding bait, the lower elastic gripping arm has a lower gripping protrusion.

11. A Holder Device for Insect Attractants that folds from a first gripping position to a second gripping position of bait which is comprised of: a lower elastic gripping arm and an upper elastic gripping arm, said arms forming an oval where one end of the curved part joins a circular support, and the other end of the curved part is open and has at each end a lower end fastener arranged on the lower elastic gripping arm, and an upper end fastener arranged on the upper elastic gripping arm, the lower elastic gripping arm has a lower gripping protrusion, and the upper elastic gripping arm has an upper gripping protrusion, said lower and upper gripping protrusions do not join or touch each other and a spike connection which is formed by an elongated spike neck, formed by a rigid-flexible member which allows forming an angle or keeping the elongated spike neck straight.

12. A Holder Device for Insect Attractants that folds from a first gripping position to a second gripping position of bait in accordance with claim 11, wherein said rigid-flexible member is inserted at one end with a coupling of arms for rigid-flexible member and at the opposite end by a circular coupling support for rigid-flexible member, said union can be made in a fixed or removable manner.

13. A Holder Device for Insect Attractants that folds from a first gripping position to a second gripping position of bait in accordance with claim 11, wherein the coupling of arms for rigid-flexible member and at the opposite end by a coupling of circular support for rigid-flexible member are capable of housing one end of the rigid-flexible member in such a way that its placement in said couplings is firm and allows manipulating the rigid-flexible member to achieve the desired angular position for placement in the trap.

14. A Holder Device for Insect Attractants that folds from a first gripping position to a second gripping position of bait in accordance with claim 11, wherein the rigid-flexible member can be a metallic or tubular wire of malleable materials, such as a malleable plastic or metal, or any other material that can fulfill the properties of rigidity and flexibility, since this property will allow providing a desired angularity or straightness between the spike connection and the gripping arms.

15. A Holder Device for Insect Attractants that folds from a first gripping position to a second gripping position of bait which is comprised of: a lower elastic gripping arm and an upper elastic gripping arm, said arms forming an oval where one end of the curved part joins a circular support, and the other end of the curved part is open and has at each end a lower end fastener arranged on the lower elastic gripping arm, and an upper end fastener arranged on the upper elastic gripping arm, the lower elastic gripping arm has a lower gripping protrusion, and the upper elastic gripping arm has an upper gripping protrusion, said lower and upper gripping protrusions do not join or touch each other and a spike connection which is formed by an elongated spike neck, formed by a rigid-flexible member which allows forming an angle or keeping the elongated spike neck straight, the spike connection has a passed spike slot that intercepts the fastening means, thus creating a continuous channel from the tip of the spike connection the fastening means, said elongated spike slot allows the entry along the elongated spike slot of a fastener.

16. A Holder Device for Insect Attractants that folds from a first gripping position to a second gripping position of bait in accordance with claim 15, wherein the passed slot exhibits flexibility in such a way that it allows a larger-area fastener to pass along its length but of smaller area than the area of the fastening means, when the fastener is forcibly passed through a clip step formed between the passed spike slot and the fastening means, the fastener is fixed onto said fastening means.

17. A Holder Device for Insect Attractants that folds from a first gripping position to a second gripping position of bait which is comprised of: a lower elastic gripping arm and an upper elastic gripping arm, said arms form an oval where one end of the curved part joins a circular support, and the other end of the curved part is open, each end has a lower end fastener arranged on the lower elastic gripping arm, and a lower end fastener arranged on the upper elastic gripping arm, the lower elastic gripping arm has a lower gripping protrusion, and the upper elastic gripping arm has an upper gripping protrusion, the lower and upper gripping protrusions do not join or touch each other, the invention is comprised of a spike connection formed at the end of the spike neck opposite the circular support, a passed spike slot intercepts the fastening means, creating a continuous channel from the tip of the spike (30) to the fastening means, the elongated spike slot allows a fastener to enter along its length.

18. A Holder Device for Insect Attractants that folds from a first gripping position to a second gripping position of bait in accordance with claim 15, wherein the passed slot exhibits flexibility in such a way that it allows a larger-area fastener to pass along its length but of smaller area than the area of the fastening means, when the fastener is forcibly passed through a clip step formed between the passed spike slot and the fastening means, said fastener will be fixed onto the aforementioned fastening means.

19. A Holder Device for Insect Attractants that folds from a first gripping position to a second gripping position of bait which is comprised of: a lower elastic gripping arm and an upper elastic gripping arm, these arms form an oval where one end of the curved part joins a circular support, and the other end of the curved part is open, each end has a lower end fastener arranged on the lower elastic gripping arm, and a lower end fastener arranged on the upper elastic gripping arm, the lower elastic gripping arm has a lower gripping protrusion, and the upper elastic gripping arm has an upper gripping protrusion, these lower and upper gripping protrusions do not join or touch each other, comprised of a spike connection formed at the end of the spike neck opposite the circular support, a closed slot which is bounded at its ends by the upper part of the spike connection and at its lower part by a fastening means, thus creating a closed or boxed slot, this closed slot allows the insertion of a rigid or flexible hook that is introduced into the closed slot, allowing for a fastener to be firmly and practically inserted into the fastening means.
